(19) United States
(12) Patent Application Publication
(10) Pub. No.: US 2025/0071117 A1
(43) Pub. Date: Feb. 27, 2025

(54) A COMPUTATIONAL METHOD AND SYSTEM FOR THE RELIABLE BLOCKLISTING OF A DOMAIN

(71) Applicant: PROOFMARKED, INC., Middletown, DE (US)

(72) Inventor: Marco António CASTELÃO SOARES, Lourical (PT)

(21) Appl. No.: 18/848,642

(22) PCT Filed: Mar. 21, 2023
(86) PCT No.: PCT/IB2023/052768

§ 371 Date: Sep. 19, 2024

(30) Foreign Application Priority Data
Mar. 22, 2022 (PT) 117867

(51) Int. Cl. H04L 9/40

(52) U.S. Cl. CPC H04L 63/101

(57) ABSTRACT

The present solution is enclosed in the area of authentication protocols, in particular web-based authentication protocols for reliably determining the origin of a web content, namely a website, and thereby legitimise/certify such website and/or visible content, be it partly or in its entirety, under consent of the rightful proprietor. The present disclosure comprises a computational method for the reliable blocklisting of a domain which, upon the performance of a single action, allows to combine a reliable allowlist with an also reliable blocklist, thereby avoiding that undesired blockage of reliable domains occurs.

### FIELD OF THE DISCLOSURE

The present solution is enclosed in the area of authentication protocols, in particular web-based authentication protocols for reliably determining the origin of a web content, namely a website, and thereby legitimise/certify such website and/or visible content, be it partly or in its entirety, under consent of the rightful proprietor.

### PRIOR ART

Following the innovation associated with the international patent application no. PCT/IB2020/056523—Method and System for Reliable Authentication of the Origin of a

Website, further enhancements have been identified.

While the existence of blacklists/blocklists are the industry standard, to improve the above-mentioned solution, a market driven whitelist/allowlisting capacity was developed, specifically federated “to each brand digital information which consists of a registered trademark, such whitelist comprising a list of websites . . . ” associated with each brand, thus creating a hyper personalized model of trust, systems and users can relate to.

Since such allowlist capacity is actually being given to an organization who is the owner of said brand/trademark, this self-sovereign capacity enabling a market-driven allowlist of domains that is federated to each trademark.

Thus, it is organizations themselves who are telling a platform what domains/Uniform Resource Locators (URLs) indeed belong to them. This creates several areas of innovation when compared to prior art:
(a) it allows users to seamlessly know they are where they think they are;
(b) it creates an incentive of cause and effect for organizations to take ownership and control of their digital assets/domains (aka: digital sprawl);
(c) It generates a reinforcing loop that ultimately allows to generate a granular federated trust (to each brand), that aggregately creates a market driven allow list of domains that are hyper-personalized to each person, individually, as per their interests (all brands).

To go a step further in disrupting the status quo, the innovative solution of the present disclosure allows to combine such market driven allowlist with the traditional blocklist & takedown approach as a mean to solve several problems in the industry.

One of the unintended results of the GDPR policy, was that the public DNS Whois registry became useless to the industry and police forces, as a mean to distinguish a good website from a bad website. Such process is non-linear and requires too much research and diligence to issue the verdict of whether or not to block & takedown a domain.

More so, the industry and police forces rather keep a bad website active for longer, than mistakenly putting a good website out of business. A process that may take days and requires more resources than anyone can spare, being that malicious websites are 84% of the time, active for less than the necessary time it takes the industry to take action.

The present solution thereby allows to overcome the mentioned issues and to obtain the referred objectives.

### SUMMARY OF THE DISCLOSURE

The present disclosure comprises a computational method for the reliable blocklisting of a domain. The computational method may comprise the steps of:
automatically obtaining an allowlist of domains upon the computational performance of a single action, such single action involving the indication of a reported domain or of information associated with a reported domain, the reported domain being potentially malicious,
comparing the reported domain or information associated with the reported domain with the allowlist,
based on such comparison, determining whether the reported domain is to be added to a blocklist of domains which comprises a digital collection of domains which have been digitally reported and deemed as malicious, and therefrom adding the reported domain to the blocklist of domains.

The present disclosure further comprises a computational system for the reliable blocklisting of a domain. The computational system may be configured to:
automatically obtaining an allowlist of domains upon the computational performance of a single action, such single action involving the indication of a reported domain or of information associated with a reported domain, the reported domain being potentially malicious,
comparing the reported domain or information associated with the reported domain with the allowlist,
based on such comparison, determining whether the reported domain is to be added to a blocklist of domains which comprises a digital collection of domains which have been digitally reported and deemed as malicious, and therefrom adding the reported domain to the blocklist of domains.

The present disclosure may further comprise a computer program product comprising executable instructions for performing the computational method of the present disclosure.

The present disclosure may further comprise a non-transitory storage media including program instructions executable to carry out the method of the present disclosure.

### DESCRIPTION OF DRAWINGS

FIG. 1—representation of a computational method (100) according to the present disclosure, comprising the steps of:
automatically obtaining an allowlist of domains (110) upon the computational performance of a single action, such single action involving the indication of a reported domain (101) which is potentially malicious, comparing the reported domain or information associated with the reported domain with the allowlist (120),
based on such comparison, determining whether the reported domain is to be added to a blocklist of domains (130) which comprises a digital collection of domains which have been digitally reported and deemed as malicious, and therefrom adding the reported domain to the blocklist of domains.

FIG. 2—representation of a reporting mechanism according to the method and system of the present disclosure, the reporting including a button which enables a single action, which in turn may be used by a user accessing the domain www.rnybank.com by means of an Internet browser, or through information provided by industry partners (not shown). The operation of the method and system of the present disclosure allows to determine the allowlisting or the blocking and taking down of the domain.

FIG. 3—representation of the innovative concept of the present disclosure. The internet comprises a domain population which, by means of the method and system of the present disclosure, may be allowlisted or blocklisted. The method and system of the present disclosure thereby provides a reinforcing loop (R) and a balancing loop (B), in an analogous form to a population is reinforced or balanced through births and deaths. The reinforcing loop (R) provides that the domain population keeps a certain domain alive, allowlisted. The balancing loop (R) provides that the domain population turns a certain domain into a blocklisted domain. The continued operation of the method and system of the present disclosure thereby enables an ever-changing state of the allowlist, which is a dynamic market driven allowlist, being evolutionary instead of static, as is the case with the solutions known in the art.

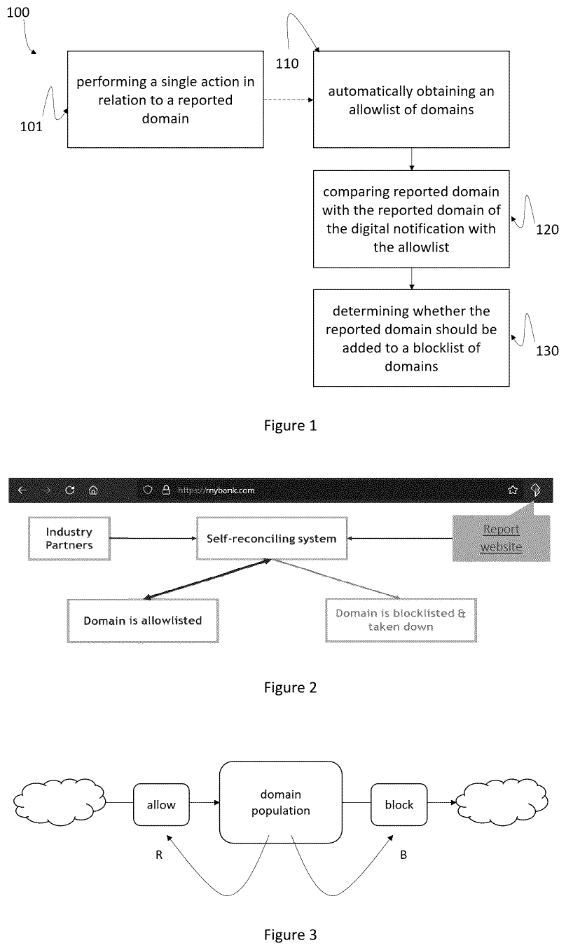

### DETAILED DESCRIPTION OF THE DISCLOSURE

The present disclosure comprises a computational method for the reliable blocklisting of a domain which allows to combine a reliable allowlist, obtained through a self-sovereign identity attributed to brand owners with an also reliable blocklist, thereby avoiding that undesired blockage of reliable domains occurs.

A reported domain or website is confronted or compared against a hyper federated list of domains that have been allowlisted and their legal owners (case by case). Thus, combining allowlists with blocklists in a self-reconciling system, that allows to automatically block a malicious website while preventing good websites from going out of business.

The allowlist validated by legal owners is automatically obtained, and it may consist of an allowlist of domains, obtained upon the computational performance of a single action, such single action involving the indication of a reported domain which is potentially malicious. Different alternatives of reporting are herein described.

Specifically, the allowlist of domains may be obtained through a brand verification system, the brand verification system obtaining at least one brand digital information which is digitally associated with each of the domains, wherein each brand digital information comprises a registered trademark and each of the domains has a Uniform Resource Indicator (URI) which is digitally associated to one of said registered trademarks, such digital association being provided in at least one server of the brand verification system.

Confronting the allowlist with a blocklist comprises comparing the reported domain or information associated with the reported domain with the allowlist. The referred obtainment may be performed by computational, automatic means, which access a database.

It is based on such comparison that it is determined whether the reported domain is to be added to a blocklist of domains which comprises a digital collection of domains which have been digitally reported and deemed as malicious, and therefrom adding the reported domain to the blocklist of domains.

In particular, if the reported domain is not part of the allowlist, it may be directly added to the blocklist. Alternatively, a further step may be provided.

Currently, the industry currently tries to drive such decisions (allowing or blocking) from several data points as a means to tell whether or not a website is good or bad (e.g. how long has the website been active for). A black box of algorithms, that train such data models to reduce false positives and false negatives. These algorithms are either not explained in detailed or examinable by third parties for real efficacy (with little to no oversight on false promises), as if no doubts could arise from an Artificial Intelligence and Machine Learning (AI&ML) decision.

On the other hand, the solution of the present disclosure drives its power from knowing what is right, which therefore enables to, together with the legitimate owners of the right domains/websites, tell the ones that are wrong and to be blocked. Enabling to act from knowledge along with the rightful proprietors.

Furthermore, prior to obtaining the allowlist, a single action is computationally performed, the single action involving the indication of a reported domain or of information associated with a reported domain, the reported domain being potentially malicious.

The solution of the present disclosure thus allows to provide a single action for any party to report a domain, initiating the procedure of self-reconciling and reliable identification and blocking of malicious domains.

The single action may consist of a click of a digital button or of any other form of input, such as speaking a sound obtained in a microphone or making a gesture obtained through a digital camera.

The solution of the present disclosure provides a self-reconciling method (and system) which provides results that are 10x times better-more effective-than existing state of the art solutions, in a more robust manner.

The determination of the addition of the reported domain to a blocklist of domains may further comprise performing a computational comparison between the website of the reported domain and a website of a domain present in the allowlist. Such computational comparison may be provided by means of computer vision. Such solution provides for the complete automation or semi-automation of the blocklisting process, without requiring the involvement of a human. As described in the present disclosure, the owner may be notified and validate.

The information associated with the reported domain may consist of a Uniform Resource Identifier (URI).

The method may further comprise performing a digital search by means of a brand registration system, the brand registration system comprising at least one server managed by an official trademark office, such server comprising a plurality of registered trademarks before such official trademark office, the digital search comprising determining if a domain name or a portion of a domain name of the reported domain corresponds to one of said registered trademarks in the brand registration system. The present solution can thus implement further actions to make sure a domain is currently rendering the information associated with its authorized, namely determining if a portion of a domain name which is not allowlisted may be related to a registered trademark. If it is not currently allowlisted, it can still by other means understand which trademark it is attempting to represent.

The digital search may be performed upon the comparison of the reported domain or information associated with the reported domain with the allowlist and therefrom determining that the reported domain is not associated with the allowlist.

The method may further comprise:
based on the digital search, computationally identifying the owner of a registered trademark resulting from the determination of correspondence, and
automatically issuing a digital notification to the identified owner.

The owner may consist of an actual owner as provided in the registered trademark or an associated entity.

Said owner may thus implement further actions. In particular, the method may further comprise the owner digitally associating a brand digital information with the domain, such digital association being performed through:
a root digital certificate, by signing and thereby creating at least one exclusive cryptographic entity which consists of a digital certificate, each digital certificate being configured to sign with a digital signature an association of a brand digital information with an URI or domain of a website,
a block in a Blockchain-based method, by creating at least one exclusive cryptographic entity which consists of a block in a Blockchain-based method, each subsequent block being configured to associate a brand digital information with an URI or domain of a website
a keyed-hash message authentication code (HMAC) verification, by associating a brand digital information with an URI or domain of a website.

Thus, the owner can then sign a domain with its Branded self-sovereign identity (BSSI)-associated with the exclusive relation between a domain and a registered trademark-or alternatively send it to be blocked & taken down.

The single action may be associated with an Internet browser, for instance through a button, optionally including an In-App browser.

Through the creation of such embedded report mechanism, the solution of the present disclosure allows end-users to report a suspicious website at the click of button.

In addition, reporting of a potentially malicious website may be provided by means of an industry partner. An industry partner consists of an entity with the ability to take down a domain.

Moreover, the method may further comprise, subsequently to the blocklisting of a certain domain or the issuing a digital notification to the identified owner, taking down the domain.

As previously described, the present disclosure may further refer to a computational system for the reliable blocklisting of a domain. Aspects of the computational system for the reliable blocklisting of a domain are subsequently described, wherein these aspects find correspondence in the aspects of the computational method which have been previously described.

The system may be configured such that the information associated with the reported domain consists of a Uniform Resource Identifier (URI).

The system may be further configured to perform a digital search by means of a brand registration system, the brand registration system comprising at least one server managed by an official trademark office, such server comprising a plurality of registered trademarks before such official trademark office, the digital search comprising determining if a domain name or a portion of a domain name of the reported domain corresponds to one of said registered trademarks in the brand registration system.

The system may be further configured to perform the digital search upon the comparison of the reported domain or information associated with the reported domain with the allowlist and therefrom determining that the reported domain is not associated with the allowlist.

The system may be further configured to:
based on the digital search, computationally identifying the owner of a registered trademark resulting from the determination of correspondence, and
automatically issuing a digital notification to the identified owner.

The system may be further configured such that the owner digitally associates a brand digital information with the domain, the configuration being such that the digital association is performed through:
a root digital certificate by signing and thereby creating at least one exclusive cryptographic entity which consists of a digital certificate, each digital certificate being configured to sign with a digital signature an association of a brand digital information with an URI or domain of a website,
a block in a Blockchain-based method by creating at least one exclusive cryptographic entity which consists of a block in a Blockchain-based method, each subsequent block being configured to associate a brand digital information with an URI or domain of a website
a keyed-hash message authentication code (HMAC) verification by associating a brand digital information with an URI or domain of a website.

The single action may be associated with an Internet browser, for instance through a button, optionally being provided in an In-App browser.

The system may further comprise at least one reporting device, the perform or provide the performance of a single action in relation to a reported domain, the reported domain being potentially malicious.

The reporting device may comprise specific means to perform the single action, through click of a digital button or of any other form of input, such as speaking a sound obtained in a microphone or making a gesture obtained through a digital camera.

Moreover, the system may be further configured such that, subsequently to the blocklisting of a certain domain or the issuing a digital notification to the identified owner, the domain is taken down.

An example applicable to the computational method and to the computational system of the present disclosure is subsequently given.

Owner “My Bank” has their mybank.com website validated through the Branded self-sovereign identity (BSSI). The method of confirming the relation between the domain and the respective registered trademark.

If the domain rnybank.com was somehow trying to impersonate the original “My Bank”, once such website has been reported by whatever means (e.g. industry partners or our own proprietary embedded report system), the solution of the present disclosure can automatically block (add to the blocklist) & optionally takedown the malicious domain effortlessly and immediately, since it allows to know from the legitimate owner “My Bank” what domains are rightly belonging to them.

The solution of the present disclosure thereby provides to combine allowlists with blocklists in a self-reconciling method or system—as per FIG. 1.

Such self-reconciling method or system can be seen as an evolutionary and ever-changing state of the market-driven allowlisted domains. Being that when a domain is somehow reported as previously mentioned, said self-reconciling system will check whether that domain is currently allowlisted.

If it is, it can then make sure such domain is currently rendering the information associated with its authorized BSSI. If it is not currently allowlisted, it can still by other means understand which trademark it is attempting to represent.

Thus, bringing such domain to the attention of the owner of such trademark. Being that said trademark owner, can then either sign that domain with his BSSI or alternatively send it to be blocked & taken down. This process is optional.

As with the passing of time, any organization should have been able to take hold of the entire digital sprawl of its digital footprint. Being that, ultimately, the purpose of the method or system is to operate automatically & seamlessly to help industry partners and police forces more effectively block & takedown ill-intended websites, with the help and support of all end-users contributing to the betterment of what can be defined as web cyber hygiene.

Such an approach, therefore, goes beyond the known in the art approach of chasing after ghosts. As it not only enables users to tell the difference between a legitimate and illegitimate website (i.e. just because it's online, doesn't mean it is worthy of one person's trust), but also empowers such self-reconciling system to drastically mitigate the false sense of security being provided by the current existing solutions (as the industry and police forces rather keep a bad website active for longer, than mistakenly putting a good website out of business).

It is this reinforcing loop that ultimately feeds into itself, as it grows organically and comprehensively. Specifically, as it allows said market-driven allowlist to grow ever larger as it hyper-federates trust granularly to each domain and each trademark. It can therefore be seen as a first-party ownership approach to a trust model, instead of a third-party assessing whether or not something can be considered to be legitimate or not (i.e. an industry player doing a judgment call of whether some website that doesn't belong to them, should or not be trusted).

The reporting device may consist of a personal computer, phone, smartphone or a tablet or another device with communication capabilities.

Although the present disclosure is mainly described in terms of computational methods and systems, the person skilled in the art understands that it is also directed to various computational devices or apparatuses.

The computational system, the reporting device, the brand verification system, the server of the brand verification system and/or the brand registration system include components to perform at least some of the example features and features of the methods described, whether through hardware components (such as memory and/or processor), software or any combination thereof.

An article for use with the computational system, the reporting device, the brand verification system, the server of the brand verification system and/or the brand registration system, such as a pre-recorded storage device or other similar computer-readable medium, including program instructions recorded on it, or a computer data signal carrying readable program instructions computer can direct a device to facilitate the implementation of the methods described herein. It is understood that such apparatus, articles of manufacture and computer data signals are also within the scope of the present disclosure.

A “computer-readable medium” means any medium that can store instructions for use or execution by a computer or other computing device, including read-only memory (ROM), erasable programmable read-only memory (EPROM) or flash memory, random access memory (RAM), a portable floppy disk, a drive hard drive (HDD), a solid state storage device (for example, NAND flash or synchronous dynamic RAM (SDRAM)), and/or an optical disc such as a Compact Disc (CD), Digital Versatile Disc (DVD) or Blu-Ray™ Disc.

As will be clear to one skilled in the art, the present disclosure should not be limited to the aspects described herein, and a number of changes are possible which remain within the terms of the present disclosure.

Of course, the aspects shown above are combinable, in the different possible forms, being herein avoided the repetition all such combinations.

1. A computational method for the reliable blocklisting of a domain wherein it comprises the steps of:
automatically obtaining an allowlist of domains upon the computational performance of a a single action, such single action involving the indication of a reported domain or of information associated with a reported domain, the reported domain being potentially malicious,
comparing the reported domain or information associated with the reported domain with the allowlist,
based on such comparison, determining whether the reported domain is to be added to a blocklist of domains which comprises a digital collection of domains which have been digitally reported and deemed as malicious, and therefrom adding the reported domain to the blocklist of domains.

2. A method according to claim 1 wherein determining whether the reported domain is to be added to a blocklist of domains further comprises performing a computational comparison, for instance by means of computer vision, between the website of the reported domain and a website of a domain present in the allowlist.

3. A method according to claim 1 wherein the allowlist of domains is obtained through a brand verification system, the brand verification system obtaining at least one brand digital information which is digitally associated with each of the domains, wherein each brand digital information comprises a registered trademark and each of the domains has a Uniform Resource Indicator (URI) which is digitally associated to one of said registered trademarks, such digital association being provided in at least one server of the brand verification system.

4. A computational method according to claim 1 wherein it comprises, prior to obtaining the allowlist, performing a single action by a reporting device in relation to a reported domain, the reported domain being potentially malicious.

5. A method according to claim 1 wherein the information associated with the reported domain consists of a Uniform Resource Identifier (URI).

6. A computational method according to claim 1 wherein it further comprises performing a digital search by means of a brand registration system, the brand registration system comprising at least one server managed by an official trademark office, such server comprising a plurality of registered trademarks before such official trademark office, the digital search comprising determining if a domain name or a portion of a domain name of the reported domain corresponds to one of said registered trademarks in the brand registration system.

7. A computational method according to claim 6 wherein the digital search is performed upon the comparison of the reported domain or information associated with the reported domain with the allowlist and therefrom determining that the reported domain is not associated with the allowlist.

8. A computational method according claim 6 wherein it further comprises
based on the digital search, computationally identifying the owner of a registered trademark resulting from the determination of correspondence, and
automatically issuing a digital notification to the identified owner.

9. A computational method according claim 8 wherein it further comprises the owner digitally associating a brand digital information with the domain, such digital association being performed through:
a root digital certificate, by signing and thereby creating at least one exclusive cryptographic entity which consists of a digital certificate, each digital certificate being configured to sign with a digital signature an association of a brand digital information with an URI or domain of a website,
a block in a Blockchain-based method, by creating at least one exclusive cryptographic entity which consists of a block in a Blockchain-based method, each subsequent block being configured to associate a brand digital information with an URI or domain of a website
a keyed-hash message authentication code (HMAC) verification, by associating a brand digital information with an URI or domain of a website.

10. A computational method according to claim 1 wherein the single action is associated with an Internet browser, optionally including an In-App browser.

11. A computational method according to claim 1 wherein, subsequently to the blocklisting of a certain domain or the issuing a digital notification to the identified owner, taking down the domain.

12. A computational system for the reliable blocklisting of a domain, wherein the system is configured to:
automatically obtaining an allowlist of domains upon the performance of a single action, such single action involving the indication of a reported domain or of information associated with a reported domain, the reported domain being potentially malicious,
comparing the reported domain or information associated with the reported domain with the allowlist,
based on such comparison, determining whether the reported domain is to be added to a blocklist of domains which comprises a digital collection of domains which have been digitally reported and deemed as malicious, and therefrom adding the reported domain to the blocklist of domains.

13. A system according to claim 12 wherein it is further configured such that determining whether the reported domain is to be added to a blocklist of domains further comprises performing a computational comparison, for instance by means of computer vision, between the website of the reported domain and a website of a domain present in the allowlist.

14. A computational system according to claim 12 wherein the allowlist of domains is obtained through a brand verification system, the brand verification system obtaining at least one brand digital information which is digitally associated with each of the domains, wherein each brand digital information comprises a registered trademark and each of the domains has a Uniform Resource Indicator (URI) which is digitally associated to one of said registered trademarks, such digital association being provided in at least one server of the brand verification system,

15. A computational system according to claim wherein the system is configured such that the information associated with the reported domain consists of a Uniform Resource Identifier (URI).

16. A computational system according to claim 12 wherein it is further configured to perform a digital search by means of a brand registration system, the brand registration system comprising at least one server managed by an official trademark office, such server comprising a plurality of registered trademarks before such official trademark office, the digital search comprising determining if a domain name or a portion of a domain name of the reported domain corresponds to one of said registered trademarks in the brand registration system.

17. A computational system according to claim 16 wherein it is further configured to perform the digital search upon the comparison of the reported domain or information associated with the reported domain with the allowlist and therefrom determining that the reported domain is not associated with the allowlist.

18. A computational system according to claim 16 wherein it is further configured to:
based on the digital search, computationally identifying the owner of a registered trademark resulting from the determination of correspondence, and automatically issuing a digital notification to the identified owner.

19. A computational system according claim 18 wherein it is further configured such that the owner digitally associates a brand digital information with the domain, the configuration being such that the digital association is performed through:
a root digital certificate by signing and thereby creating at least one exclusive cryptographic entity which consists of a digital certificate, each digital certificate being configured to sign with a digital signature an association of a brand digital information with an URI or domain of a website,
a block in a Blockchain-based method by creating at least one exclusive cryptographic entity which consists of a block in a Blockchain-based method, each subsequent block being configured to associate a brand digital information with an URI or domain of a website
a keyed-hash message authentication code (HMAC) verification by associating a brand digital information with an URI or domain of a website.

20. A computational system according to claim 19 wherein the single action is associated with an Internet browser, optionally including an In-App browser.

21. (canceled)

22. (canceled)

23. (canceled)

24. (canceled)
